(19) United States
(12) Patent Application Publication
(10) Pub. No.: US 2024/0397313 A1
(43) Pub. Date: Nov. 28, 2024

(54) REMOTE USER EQUIPMENT (UE) AUTHORIZATION FOR RECEIVING A SERVICE

(71) Applicant: Telefonaktiebolaget LM Ericsson (publ), Stockholm (SE)

(72) Inventors: Zhang FU, Stockholm (SE); Juying GAN, Shanghai (CN)

(73) Assignee: Telefonaktiebolaget LM Ericsson (publ), Stockholm (SE)

(21) Appl. No.: 18/693,444

(22) PCT Filed: Sep. 13, 2022
(86) PCT No.: PCT/EP2022/075406

§ 371 Date: Mar. 19, 2024

(30) Foreign Application Priority Data
Sep. 20, 2021 (WO) PCT/CN2021/119479

(51) Int. Cl. H04W 12/06; H04W 76/20; H04W 76/40; H04W 92/18

(52) U.S. Cl. CPC H04W 12/06; H04W 76/20; H04W 76/40; H04W 92/18

(57) ABSTRACT

A method (300) for determining whether a remote user equipment, UE (101), is authorized to receive a service. The method includes a relay UE (102) receiving from the remote UE a request message (202) indicating that the remote UE is requesting to receive the service. The method also includes, as a result of receiving the request message, the relay UE performing an authorization process that comprises: the relay UE transmitting, via a base station (104), a message (204) for triggering a first network function (112) to determine whether the remote UE is authorized to receive the service. The method also includes the relay UE receiving, via the base station, a response to the message, wherein the response indicates whether nor not the remote UE is authorized to receive the service.

### TECHNICAL FIELD

Disclosed are embodiments related to enabling a relay user equipment (UE) to determine whether a remote UE is authorized to receive a service.

### BACKGROUND

Two user equipments (UEs) can communicate with each other either directly via a sidelink (SL) interface (e.g., the PC5 SL interface). As used herein, a UE is any device (e.g., smartphone, computer, tablet, sensor, appliance, vehicle, etc.) capable of wireless communication with another device (e.g., another UE or an access point or an access network, such as a base station or a radio access network (RAN)). This direct communication between two UEs enables one of the UE to function as a relay for the other UE. The UE that functions as a relay is referred to herein as a relay UE and the other UE is referred to herein as a remote UE. The relay UE may be a Layer-3 UE-to-Network relay. The relay UE provides functionality to support connectivity to the network for remote UEs. The relay UE entity can be used for both public safety services and commercial services (e.g. interactive service).

The first standardization effort in 3GPP for the SL interface dates back to release 12 (Rel-12), which targeted public safety use cases. The SL interface is specified to allow a remote UE to send data packets directly to a relay UE (i.e., without sending the data packets to the network), which can then forward the data packets to a network node (e.g., a base station). Likewise, the relay UE can receive from the network data packets addressed to the remote UE and forward these data packets to the remote UE over the SL interface. Accordingly, a remote UE can obtain network services via the relay UE even when the remote UE is out of the network's cell coverage.

### SUMMARY

Certain challenges presently exist. For example, in some envisioned scenarios a remote UE may request a relay UE to take some action to enable the remote UE to receive a service (e.g., join a Multicast Broadcast Service (MBS) session), but the relay UE does not have information enabling the relay UE to determine whether the UE is authorized to receive the requested service.

Accordingly, in one aspect there is provided a method performed by a relay UE for determining whether a remote UE is authorized to receive a requested service. The method includes the relay UE receiving from the remote UE a request message indicating that the remote UE is requesting to receive the service. The method also includes, as a result of receiving the request message, the relay UE performing an authorization process that comprises: the relay UE transmitting, via a base station, a message for triggering a first network function to determine whether the remote UE is authorized to receive the service. The method also includes the relay UE receiving, via the base station, a response to the message, wherein the response indicates whether nor not the remote UE is authorized to receive the service.

In another aspect there is provided a computer program comprising instructions which when executed by processing circuitry of a relay UE causes the relay UE to perform any of the relay UE methods disclosed herein. In one embodiment, there is provided a carrier containing the computer program wherein the carrier is one of an electronic signal, an optical signal, a radio signal, and a computer readable storage medium.

In another aspect there is provided a relay UE that is configured to perform the relay UE methods disclosed herein. In some embodiments, the relay UE comprises memory and processing circuitry coupled to the memory, wherein the memory contains instructions executable by the processing circuitry to configure the relay UE to perform the relay UE methods disclosed herein.

In another aspect there is provided a method performed by a first network function for determining whether a remote UE is authorized to receive a requested service. The method includes receiving a remote UE report message generated by a relay UE, the remote UE report message comprising a service identifier and a remote UE identifier. The method further includes in response to receiving the remote UE report message, the first network function performing a process for determining whether the remote UE is authorized to receive the service identified by the service identifier.

In another aspect there is provided a computer program comprising instructions which when executed by processing circuitry of a first network function causes the first network function to perform any of the first network function methods disclosed herein. In one embodiment, there is provided a carrier containing the computer program wherein the carrier is one of an electronic signal, an optical signal, a radio signal, and a computer readable storage medium.

In another aspect there is provided a first network function that is configured to perform the first network function methods disclosed herein. In some embodiments, the first network function comprises memory and processing circuitry coupled to the memory, wherein the memory contains instructions executable by the processing circuitry to configure the first network function to perform the first network function methods disclosed herein.

An advantage of the embodiments disclosed herein is that they enable a relay UE to determine whether or not a remote UE is authorized to receive a service requested by the remote UE. This has the advantage of reducing network load because if the relay UE determines that the remote UE is not authorized to receive the service then the relay UE will refrain from performing the signaling that is necessary for the remote UE to receive the service.

### BRIEF DESCRIPTION OF THE DRAWINGS

The accompanying drawings, which are incorporated herein and form part of the specification, illustrate various embodiments.

FIG. 1 shows a communication system according an embodiment.

FIG. 2 is a message flow diagram illustrating a message flow according to an embodiment.

FIG. 3A is a flowchart illustrating a process according to some embodiments.

FIG. 3B is a flowchart illustrating a process according to some embodiments.

FIG. 4 is a block diagram of a relay UE according to some embodiments.

FIG. 5 is a block diagram of a network function according to some embodiments.

### DETAILED DESCRIPTION

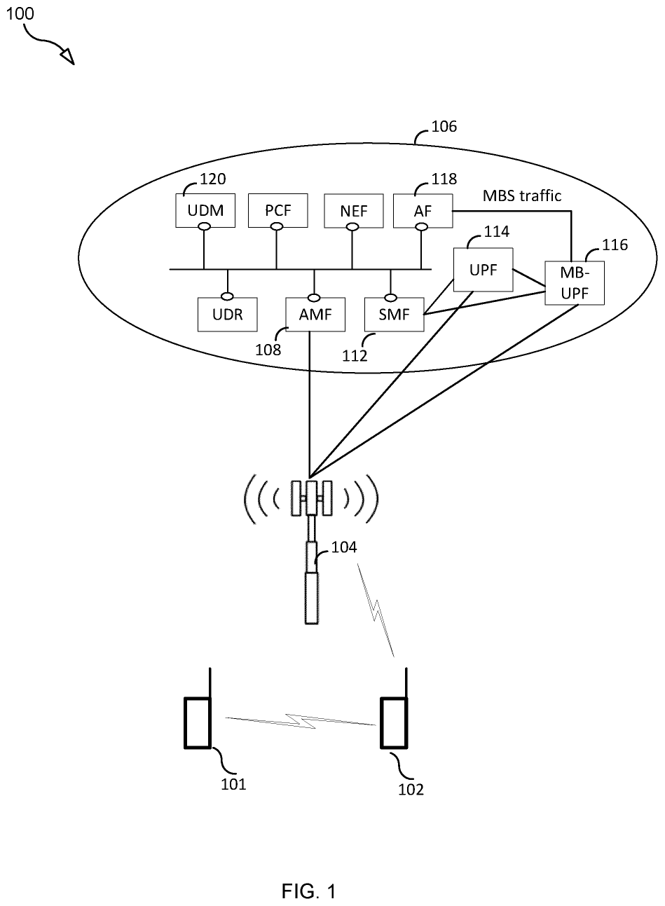

FIG. 1 illustrates a communication system 100 according to an embodiment. In this example, system 100 is a Third Generation Partnership Project (3GPP) Fifth-Generation (5G) system (5GS). System 100 includes a first UE 101 (referred to herein as the “remote” UE) and a second UE 102 (referred to herein as the “relay” UE), which may function as a UE-to-Network (UE-NW) relay. System 100 also includes a radio access network (RAN) access point AP 104 (a.k.a., “base station 104”), which in this example is a Next Generation (NG) RAN (NG-RAN) base station (denoted “gNB”), a core network 106, which in this example is a 5G core network (5GC). As shown in FIG. 1, 5GC includes, among other entities, an Access and Mobility Management Function (AMF) 108, a Session Management Function (SMF) 112, a User Plane Function (UPF) 114, a Multicast/Broadcast UPF 116 (MB-UPF 116), an Application Function (AF) 118, and User Data Management (UDM) function 120. AF 118 in this embodiment transmits MBS traffic for a particular MBS session to MB-UPF 116 which is operable to forward traffic towards relay UE 102 by either forwarding the traffic to gNB 104 or by forwarding the traffic to UPF 114, which then forwards the traffic directly to gNB 104, which then transmits the traffic so that it can be received by relay UE 102. Relay 102 may then forward the MBS traffic to remote UE 101 (assuming remote UE 101 has requested to join the MBS session and relay UE 102 has determined that remote UE 101 is authorized to join the MBS session).

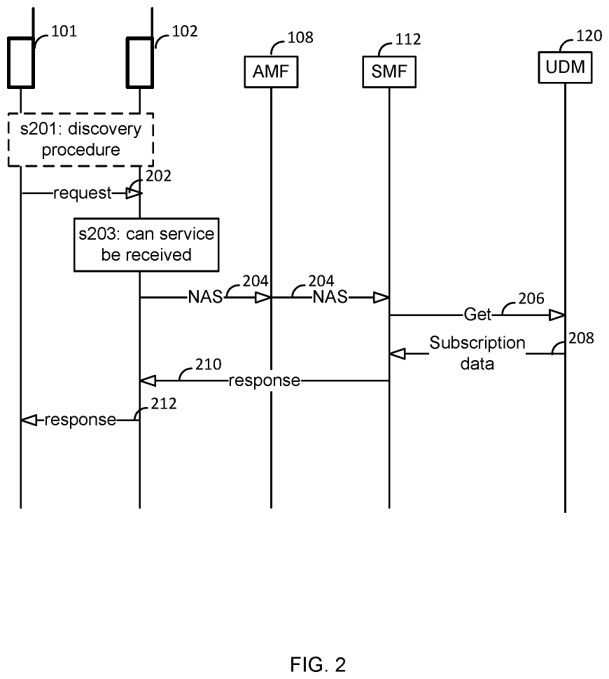

FIG. 2 is a message flow diagram illustrating a process according to some embodiments. As shown in FIG. 2, the process may begin in step s201, where remote UE 101 and relay UE 102 perform a discovery procedure so that remote UE 101 can discovery relay UE 102, or vice-versa. In some embodiments, remote UE 101 initiates the discovery procedure, and in other embodiments UE 102 initiates the discovery procedure. In some embodiments the discovery procedure is a discovery procedure defined in 3GPP Technical Specification (TS) 23.304 V2.0.0, such as the “5G ProSe UE-to-Network Relay Discovery” procedure described in section 6.3.2.3 of TS 23.304.

After remote UE 101 discovers relay UE 102, remote UE 101 transmits to relay UE 102 a request message 202 indicating that the remote UE is requesting to receive a service. In one embodiment, the request message 202 is a message that is used to establish a layer-2 link between remote UE 101 and relay UE 102. For example, in one embodiment, request message 202 is a Direct Communication Request message that is sent to initiate a unicast layer-2 link establishment. In another embodiment, request message 202 is sent by remote UE 101 after the layer-2 link between itself and relay UE 102 has been established. In such an embodiment, request message may be a Radio Resource Control (RRC) message or PC5 Signaling Protocol message. For instance, in one embodiment, remote UE 101 transmits the requests message by transmitting to relay UE 102 a Packet Data Convergence Protocol (PDCP) protocol data unit (PDU), where the request message is included in the payload portion of the PDCP PDU and the service data unit (SDU) type field in the header of the PDCP PDU contains a type value indicating that the payload portion contains a PC5 Signaling Protocol message.

Request message 202 includes a service identifier. For instance, in some embodiments, request message 202 indicates that remote UE 102 is requesting to join an MBS session and request message 202 includes the MBS session ID of the MBS session. The MBS session ID may be a temporary mobile group identity (TMGI) or a multicast IP address.

After receiving request message 202 and determining that the message indicates that the remote UE 101 is requesting to receive a service, relay UE 102 checks to see whether it is already receiving the service, and, if it is not already receiving the service, relay UE 102 checks whether relay UE 102 can receive the service. For instance, if the request from remote UE 101 is a request to join an MBS session, relay UE 102 determines whether relay UE 102 has already joined that MBS session, and, if relay UE 102 has not already joined the MBS session, relay UE 102 determines if relay UE 102 can join the MBS session. For example, relay UE checks 102 if it has received the service announcement about the MBS session, if the MBS session is allowed in the current area, e.g. the current cell or TA. Also, if there is no PDU session that can be associated with the MBS session, the relay UE 102 will establish a PDU session according to the data network name (DNN) and a network slice (e.g., S-NSSAI) of the MBS session.

After determining that relay UE 102 is receiving, or can receive, the service, relay UE 102 transmits a Non-Access Stratus (NAS) message 204 to SMF 112 to trigger SMF 112 to check whether remote UE 102 is allowed to receive the receive (e.g., is allowed to receive the traffic from the MBS session). NAS message 204 may be a new type of NAS message, which can be called “MBS authorization request,” or NAS message 204 could be an extended version of the remote UE report that is defined in TS 24.30 (i.e., extended to include at least a service identifier (e.g., MBS session ID)). In one embodiment, message 204 includes the remote UE ID (e.g. a Subscriber Permanent Identifier (SUPI) or an encrypted SUPI, or a Prose Remote User Key Identifier (PRUK ID)), a PDU session ID associated with the service, and the service ID (e.g., MBS session ID). If the UE ID is an encrypted SUPI, then SMF 112 can use, for example, the procedure described in international patent application no. PCT/CN2021/095349 to obtain the SUPI.

In one embodiment, when relay UE 102 transmits message 204 to SMF 112, the message is first received by AMF 108, which then forwards message 204 to SMF 112. When AMF 108 receives message 204, it can forward message 204 to the correct SMF according to the PDU session ID.

NAS message 204 triggers SMF 112 to determine whether remote UE 101 is authorized to receive the service identified by the service ID included in the message. For example, after SMF 112 receives the NAS message 204, SMF 112 checks if remote UE 101 is authorized the receives the traffic of that MBS session based on the MBS subscription data of remote UE 101. SMF 112 gets the MBS subscription data by transmitting a get subscription data message 206 to UDM 120 (e.g., using via Nudm_SDM_service) and then receiving from UDM 120 a response message 208 that includes the requested subscription data.

After SMF 112 receives the requested subscription data, SMF 112 uses the subscription data to check whether it indicates that remote UE 101 is authorized to receive the service and then sends a response message 210 to relay UE 102 indicating whether or not remote UE 101 is authorized. Response message 210 could be an extended version of the remote UE report response message defined in TS 24.301 which is extended to include a new field to indicate if the remote UE is authorized for service (e.g., the MBS session) or not.

In the case where remote UE 101 is requested to join an MBS session, then, if relay UE 102 determines, based on the response from SMF 112, that remote UE 101 is authorized to join the session and if relay UE 102 has not yet joined the session, the relay UE 102 joins the MBS session as defined in clause 7.2.1 in TS 23.247. Lastly, relay UE 101 sends to remote UE 101 a response message 212 to indicate whether or not the request to receive the service is accepted or not.

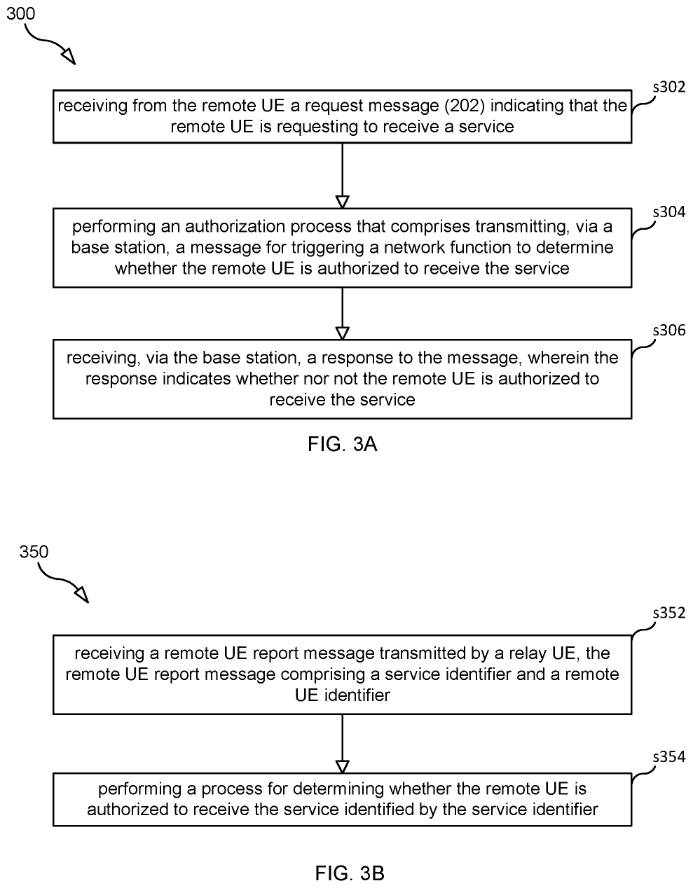

FIG. 3A is a flowchart illustrating a process 300, according to an embodiment, that is performed by relay UE 102 for determining whether the remote UE 101 is authorized to receive a service. Process 300 may begin in step s302.

Step s302 comprises the relay UE (102) receiving from the remote UE a request message (202) indicating that the remote UE is requesting to receive the service.

Step s304 comprises, as a result of receiving the request message, the relay UE performing an authorization process that comprises: the relay UE transmitting, via a base station (104), a message (204) for triggering a first network function (112) to determine whether the remote UE is authorized to receive the service.

Step s306 comprises the relay UE receiving, via the base station, a response to the message, wherein the response indicates whether nor not the remote UE is authorized to receive the service.

In some embodiments, the service is a specific Multicast Broadcast Service, MBS, session and the request message indicates that the remote UE is requesting to join the MBS session.

In some embodiments, the message transmitted by the relay UE comprises a message type identifier that specifies that the message is a remote UE report message.

In some embodiments, the message transmitted by the relay UE comprises a message type identifier that specifies that the message is a service authorization request message that includes a PDU session ID identifying PDU session associated with the service. In some embodiments, the message is received by a second network function (108) that forwards the message to the first network function (112) according to the PDU session ID in the message.

In some embodiments, the message comprises a UE identifier, ID; and a service ID. In some embodiments, the UE ID is a Subscription Permanent Identifier (SUPI) or an encrypted SUPI, or a Prose Remote User Key Identifier (PRUK ID), and the service ID is an MBS session ID.

In some embodiments, the authorization process further comprises the relay UE determining whether the relay UE has previously joined the service. In some embodiments, the authorization process further comprises as a result of determining that the relay UE has not previously joined the service, the relay UE determining whether the relay UE may join the service, wherein determining whether the relay UE may join the service comprises the relay UE determining whether the service is allowed in the area in which the relay UE is located.

In some embodiments, the response indicates that the remote UE may join the service, and the method further comprises, after receiving the response: the relay UE joining the service; and the relay UE transmitting a response message to the remote UE, wherein the response message indicating that the remote UE may join the service.

In some embodiments, joining the service comprises the relay UE transmitting a Packet Data Unit, PDU, Session Modification Request comprising an identifier identifying the service. In some embodiments, the request message is a control plane message that identifies the service (e.g., TMGI or multicast IP address). In some embodiments, the control plane message is a PC5 Signaling Protocol message or a Radio Resource Control (RRC) message.

In some embodiments, receiving the control plane message comprises receiving a Packet Data Convergence Protocol, PDCP, protocol data unit, PDU, comprising a payload portion comprising the control plane message and a header containing a type value indicating that the payload portion contains a PC5 Signaling Protocol message.

FIG. 3B is a flowchart illustrating a process 350, according to an embodiment, that is performed by a first network function (e.g., SMF 112). Process 350 may begin in step s352.

Step s352 comprises the first network function receiving a remote UE report message (204) transmitted by a relay UE (101), the remote UE report message comprising a service identifier and a remote UE identifier.

Step s354 comprises, in response to receiving the remote UE report message (204), the SMF performing a process for determining whether the remote UE is authorized to receive the service identified by the service identifier. In some embodiments, this process includes the first network function obtaining subscription data for the remote UE 101 by sending a subscription data request message 206 to UDM 120, as described above, as using the subscription data to determine whether remote UE 101 is authorized. After determining whether the remote UE is authorized to receive the service identified by the service identifier, the first network function transmits response message 210 to relay UE 102.

In some embodiments, the process for determining whether the remote UE is authorized to receive the service identified by the service identifier comprises the first network function obtaining subscription data for the remote UE and using the obtained subscription data to determine whether the remote UE is authorized.

In some embodiments, the remote UE report message was forwarded to the first network function by another network function (e.g., AMF 108).

In some embodiments, the method also includes the SMF, after making the determination, transmitting a response message (see message 210) towards the relay UE, wherein the response message indicates whether or not the remote UE is authorized.

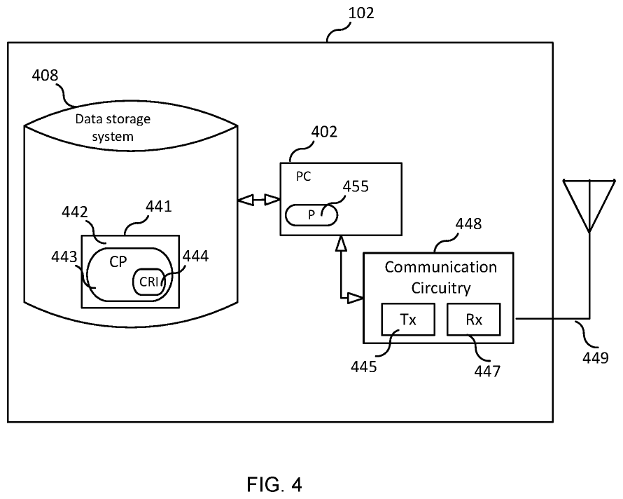

FIG. 4 is a block diagram of a relay UE 102, according to some embodiments. As shown in FIG. 4, relay UE 102 may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like); communication circuitry 448, which is coupled to an antenna arrangement 449 comprising one or more antennas and which comprises a transmitter (Tx) 445 and a receiver (Rx) 447 for enabling relay UE 102 to transmit data and receive data (e.g., wirelessly transmit/receive data); and a local storage unit (a.k.a., “data storage system”) 408, which may include one or more non-volatile storage devices and/or one or more volatile storage devices. In embodiments where PC 402 includes a programmable processor, a computer program product (CPP) 441 may be provided. CPP 441 includes a computer readable medium (CRM) 442 storing a computer program (CP) 443 comprising computer readable instructions (CRI) 444. CRM 442 may be a non-transitory computer readable medium, such as, magnetic media (e.g., a hard disk), optical media, memory devices (e.g., random access memory, flash memory), and the like. In some embodiments, the CRI 444 of computer program 443 is configured such that when executed by PC 402, the CRI causes relay UE 102 to perform steps described herein (e.g., steps described herein with reference to the flow charts). In other embodiments, relay UE 102 may be configured to perform steps described herein without the need for code. That is, for example, PC 402 may consist merely of one or more ASICs. Hence, the features of the embodiments described herein may be implemented in hardware and/or software.

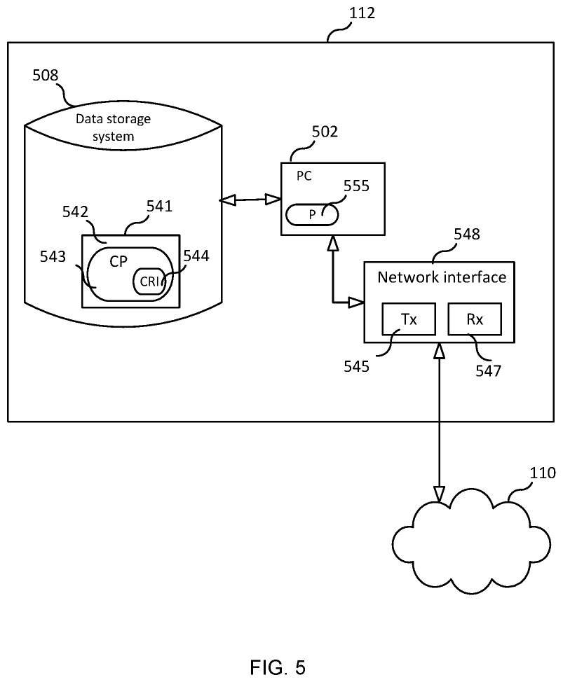

FIG. 5 is a block diagram of SMF 112, according to some embodiments. As shown in FIG. 5, SMF 112 may comprise: processing circuitry (PC) 502, which may include one or more processors (P) 555 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., SMF 112 may be a distributed computing apparatus); at least one network interface 548 comprising a transmitter (Tx) 545 and a receiver (Rx) 547 for enabling SMF 112 to transmit data to and receive data from other nodes connected to a network 110 (e.g., an Internet Protocol (IP) network) to which network interface 548 is connected (directly or indirectly) (e.g., network interface 548 may be wirelessly connected to the network 110, in which case network interface 548 is connected to an antenna arrangement); and a storage unit (a.k.a., “data storage system”) 508, which may include one or more non-volatile storage devices and/or one or more volatile storage devices. In embodiments where PC 502 includes a programmable processor, a computer program product (CPP) 541 may be provided. CPP 541 includes a computer readable medium (CRM) 542 storing a computer program (CP) 543 comprising computer readable instructions (CRI) 544. CRM 542 may be a non-transitory computer readable medium, such as, magnetic media (e.g., a hard disk), optical media, memory devices (e.g., random access memory, flash memory), and the like. In some embodiments, the CRI 544 of computer program 543 is configured such that when executed by PC 502, the CRI causes SMF 112 to perform steps described herein (e.g., steps described herein with reference to the flow charts). In other embodiments, SMF 112 may be configured to perform steps described herein without the need for code. That is, for example, PC 502 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for determining whether a remote user equipment (UE) is authorized to receive a service, the method comprising:
a relay UE receiving from the remote UE a request message indicating that the remote UE is requesting to receive the service;
as a result of receiving the request message, the relay UE performing an authorization process that comprises: the relay UE transmitting, via a base station, a message for triggering a first network function to determine whether the remote UE is authorized to receive the service; and
the relay UE receiving, via the base station, a response to the message, wherein the response indicates whether or not the remote UE is authorized to receive the service.

2. The method of claim 1, wherein the service is a specific Multicast Broadcast Service (MBS) session and the request message indicates that the remote UE is requesting to join the MBS session.

3. The method of claim 1, wherein the message transmitted by the relay UE comprises a message type identifier that specifies that the message is a remote UE report message.

4. The method of claim 1, wherein the message transmitted by the relay UE comprises a message type identifier that specifies that the message is a service authorization request message that includes a PDU session ID identifying PDU session associated with the service.

5. The method of claim 4, wherein the message is received by a second network function that forwards the message to the first network function according to the PDU session ID in the message.

6. The method of claim 1, wherein the message comprises:
a UE identifier (ID); and
a service ID.

7. The method of claim 6, wherein
the UE ID is a Subscription Permanent Identifier (SUPI) or an encrypted SUPI, or a Prose Remote User Key Identifier (PRUK ID), and
the service ID is an MBS session ID.

8. The method of claim 1, wherein the authorization process further comprises:
the relay UE determining whether the relay UE has previously joined the service.

9. The method of claim 8, wherein
the relay UE is located in an area, and
the authorization process further comprises:
after determining that the relay UE has not previously joined the service, the relay UE determining whether the relay UE may join the service, wherein
determining whether the relay UE may join the service comprises the relay UE determining whether the service is allowed in the area in which the relay UE is located.

10. The method of claim 1, wherein
the response indicates that the remote UE may join the service, and
the method further comprises, after receiving the response:
the relay UE joining the service; and
the relay UE transmitting a response message to the remote UE, wherein the response message indicating that the remote UE may join the service.

11. The method of claim 10, wherein joining the service comprises the relay UE transmitting a Packet Data Unit (PDU) Session Modification Request comprising an identifier identifying the service.

12. The method of claim 1, wherein the request message is a control plane message that identifies the service.

13. The method of claim 12, wherein the control plane message is a PC5 Signaling Protocol message or a Radio Resource Control message.

14. The method of claim 13, wherein receiving the control plane message comprises receiving a Packet Data Convergence Protocol (PDCP) protocol data unit comprising a payload portion comprising the control plane message and a header containing a type value indicating that the payload portion contains a PC5 Signaling Protocol message.

15. A method performed by a first network function, the method comprising:
receiving a remote UE report message generated by a relay UE, the remote UE report message comprising a service identifier and a remote UE identifier; and
in response to receiving the remote UE report message, the first network function performing a process for determining whether the remote UE is authorized to receive the service identified by the service identifier.

16. The method of claim 15, wherein the first network function is a Session Management Function (SMF).

17-19. (canceled)

20. A non-transitory computer readable storing medium storing a computer program comprising instructions which when executed by processing circuitry of a relay UE causes the relay UE to perform the method of claim 1.

21-22. (canceled)

23. A relay UE, the relay UE comprising:
processing circuitry; and
a memory, the memory containing instructions executable by the processing circuitry, wherein the relay UE is configured to:
receive from the remote UE a request message indicating that the remote UE is requesting to receive the service;
as a result of receiving the request message, perform an authorization process that comprises: the relay UE transmitting, via a base station, a message for triggering a first network function to determine whether the remote UE is authorized to receive the service; and
receive, via the base station, a response to the message, wherein the response indicates whether or not the remote UE is authorized to receive the service.

24. (canceled)

25. A non-transitory computer readable storing medium storing a computer program comprising instructions which when executed by processing circuitry of a network function causes the network function to perform the method of claim 15.

26-27. (canceled)

28. A network function, the network function comprising:
a receiver for receiving a remote UE report message generated by a relay UE, the remote UE report message comprising a service identifier and a remote UE identifier;
processing circuitry; and
a memory, the memory containing instructions executable by the processing circuitry, wherein the network function is configured to:
in response to receiving the remote UE report message, perform a process for determining whether the remote UE is authorized to receive the service identified by the service identifier.

29. (canceled)
